(19) United States
(12) Patent Application Publication
(10) Pub. No.: US 2016/0098806 A1
(43) Pub. Date: Apr. 7, 2016

(54) ONLINE SCHEDULING OF REAL ESTATE TOURS

(71) Applicant: Redfin Corporation, Seattle, WA (US)

(72) Inventors: Andrew Chen, San Francisco, CA (US); Curtis Howell, San Francisco, CA (US); Andy Taylor, San Francisco, CA (US); Jennifer Chao, San Francisco, CA (US); Meghan Kilgore, Seattle, WA (US); April Alexander, Seattle, WA (US); Lisa Jones, Seattle, WA (US); Justin Yan, Seattle, WA (US)

(21) Appl. No.: 14/875,939

(22) Filed: Oct. 6, 2015

Related U.S. Application Data
(60) Provisional application No. 62/060,112, filed on Oct. 6, 2014.

(51) Int. Cl. G06Q 50/16; G06F 3/0484; G06F 17/30

(52) U.S. Cl. CPC G06Q 50/16; G06F 17/30867; G06F 3/04847; G06F 3/04842

(57) ABSTRACT

A computer-implemented method of coordinating a tour of a listed property is described herein. A first electronic multiple-listing service (MLS) database is accessed over a network. The first MLS database includes data describing the listed property. Multiple enumerated entries characterizing the availability for touring of the listed property are identified. A memory device on which are stored agent-data entries characterizing the availability for showing the listed property of multiple agents is accessed. At least one confirmed time period during which the listed property is available for touring and an agent is available to show the listed property is determined. A graphical user interface (GUI) is generated to a display device. The GUI presents user-selectable icons representing time periods during which the property is not unavailable for touring. At least one of the icons is labeled as being associated with a confirmed time period.

### PRIORITY CLAIM

This patent application claims priority from U.S. Provisional App. No. 62/060,112 filed Oct. 6, 2014 and entitled “Online Scheduling of Real Estate Tours,” the entirety of which is hereby incorporated by reference as if fully set forth herein.

### BACKGROUND

Real estate transactions often involve a buyer, a seller, and one or more agents (e.g., a listing agent for the seller and buyer's agent for the buyer). In a typical contemporary purchase transaction, the seller lists a property using a listing server, often through a listing agent, while buyers go through an online search process to identify potential properties to buy. Once the prospective buyer identifies a property he/she would like to visit, the buyer can attempt to schedule a showing of the listed property, perhaps using an online service, that allows the buyer to better assess the extent of his/her interest in purchasing the property. However, because of the many circumstances and parties involved in a potential real estate transaction, it is often difficult for buyers and sellers to coordinate a property showing. Efficiently and quickly scheduling these showings can be extremely difficult, if not impossible, even using online services.

### BRIEF DESCRIPTION OF THE DRAWING

Preferred and alternative embodiments of the present invention are described in detail below with reference to the following drawing figures:

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is a flowchart illustrating a process according to an embodiment of the invention;

FIG. 4 illustrates a table of enumerated entries associated with an MLS database that may be employed by an embodiment of the invention; and

FIGS. 5-6 are screenshots illustrating functionality of one or more embodiments of the invention.

### DETAILED DESCRIPTION

Traditionally, the residential real estate industry relied on the monopoly of information only available to real estate agents to command a premium commission for each listing. Nearly all listings in a region are contained in a data feed called the Multiple Listing Service (MLS). Each region has a specific MLS feed and the information on the MLS is only available to licensed agents with an office in the particular region. Real estate agents have charged and continue to charge around 6% commission on average (split between the buyer side agent and seller side agent) for their services, which rely on access to the information on the MLS. The high commission rate is not favorable to the consumer, but there was no viable alternative to the traditional real estate model to buy or sell a home.

Even with the introduction of the Internet, which drastically changed the way consumers bought electronics, books, stocks, or airline tickets, the real estate industry resisted change. The agent-customer relationship was protected—along with the 6% commission—through the industry's tight control over the information on the MLS databases of properties for sale. Moreover, items such as plane tickets or stocks were standardized commodities that consumers purchased many times over a lifetime, but every home has unique characteristics and people buy them infrequently.

Redfin™ was the only brokerage that capitalized on the changes in consumer habits and overcame the market challenges by developing a business model that no longer ran on personal connections, closely held information, and commissions paid to agents. Redfin utilized the Internet to streamline homebuying by shifting the power to consumers in giving them one-click access to data to which only agents once were privy. Redfin made it possible for consumers to look through MLS listings themselves and shop for a home without the need of an agent. Redfin developed technology to display homes for sale on an online map before Google® map was available so that a prospective homebuyer could easily find homes within a geographic area on the Redfin website. Ten years ago, almost no one started their home search online. Now, according to National Association of Realtors (NAR), more than 90% of homebuyers use the Internet when shopping, and half do it from a mobile device.

But even this simple change was met with great resistance. Traditional real estate agents continued to selectively withhold listing data, until the 2008 U.S. v. National Association of Realtors decision that made sure NAR rules for brokers' conduct allowed for Internet-based brokerage services. All brokerages would have the same access to the MLS data, and most listing information—such as how long a home has been on the market, or how its price has changed over time—could be distributed online to consumers.

Today, this aspect of Redfin's technology and service has been replicated by other non-brokerage companies that organize all the MLS data onto a single consumer-friendly site so that consumers can shop for homes, such as Zillow or Trulia. Although Zillow and Trulia are not brokerages and do not have access to the MLS feeds, these websites aggregate listings through real estate agents manually inputting their listing into the Zillow/Trulia platform. Therefore, these sites act as simple listing services, much like an advertising platform for real estate agents. In contrast with Redfin, these sites do not disrupt the agent-customer relationship aspect of residential real estate but, rather, enable the traditional way of doing business in real estate. Moreover, since these sites rely on agents voluntarily listing MLS information, only about 80% of MLS listings are posted. Redfin is a real estate brokerage that employs licensed real estate agents. Consequently, they have direct access to the MLS data and all the listings are posted on their site. Additionally, the Redfin site is not just an advertising platform; Redfin actually offers services through the real estate agents they employ.

Since Redfin agents do not need to find and recommend homes—customers do that on their own using Internet listings—Redfin can charge a significantly lower fee than that earned by agents within the traditional model (totaling approximately 1.5% in fees compared to the traditional 3%). Further departing from the model of traditional brokerages, Redfin pays their agents with an annual salary rather than commissions and ties bonuses to customer reviews in addition to their performance. Redfin agents do not need to spend nearly as much time drumming up business as their traditional counterparts because Redfin feeds them a steady stream of leads captured through its website. In Washington state's King County alone, Redfin's 220 agents compete with Windermere (2,260 agents) and John L. Scott and Coldwell Banker (each more than 1,100 agents).

Redfin continues to combine technology and service to provide more efficient and cost-effective ways to buy or sell a home by allowing homebuyers to schedule a viewing through one-click access. Immediate and current information is more important than ever to brokerage services. Competition among buyers is fierce in strong markets. Redfin posts newly listed houses on their site within hours, if not minutes, of their availability, giving customers an advantage when searching for homes. However, virtually no one buys a house without visiting the property first. A lot of time is spent setting up viewings with agents, and the availability of a viewing might determine who purchases the property. Redfin is now streamlining this process as well. Redfin now offers their customers the ability to check the availability and schedule viewings through the Redfin website. The ability to schedule viewings immediately, without the need to involve an agent to coordinate the scheduling, is a huge competitive advantage for buyers, and hence, their brokers.

Prospective buyers no longer have to waste time calling agents hoping that a viewing is available that fits their busy schedule. They can now instantly tell when a viewing is available and maximize the amount of properties they are able to see. Once again, Redfin is utilizing listing data in a meaningful way and taking away another requirement of the traditional agent-customer relationship, resulting in a more-efficient, superior process. Consumers will quickly grow accustomed to Redfin's easy and efficient scheduling tool, and competitors will soon be faced with providing a similar on-demand-like scheduling tool.

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

An embodiment provides a system and method of providing online real estate tour scheduling, online real estate virtual tour scheduling, as well as appointment scheduling for other service industries. An embodiment increases the efficiency of these types of appointment scheduling processes by removing manual steps, and improves the user experience by decreasing the number of back-and-forth communications necessary to schedule and confirm an appointment.

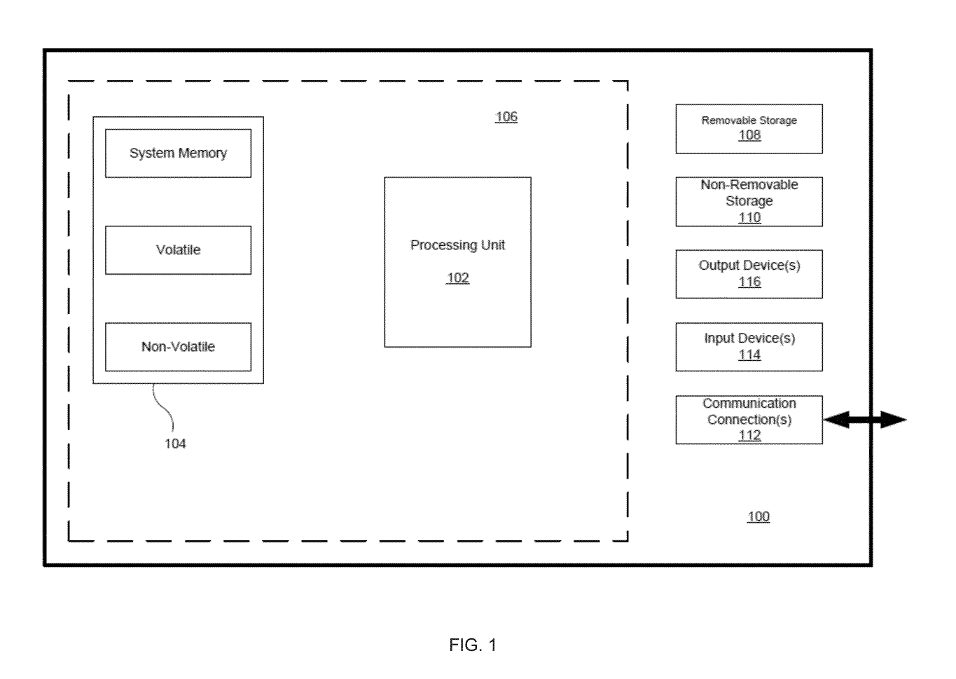

FIG. 1 illustrates an example of a computing system environment 100 in which an embodiment of the invention may be implemented. The computing system environment 100, as illustrated, is an example of a suitable computing environment; however it is appreciated that other environments, systems, and devices may be used to implement various embodiments of the invention as described in more detail below.

Embodiments of the invention are operational with numerous general-purpose or special purpose computing system environments or configurations. Examples of well-known computing systems, environments, and/or configurations that may be suitable for use with embodiments of the invention include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

Embodiments of the invention may be described in the general context of computer-executable instructions, such as program modules being executed by a computer. Generally, program modules include routines, programs, objects, components, data structures, etc. that perform particular tasks or implement particular abstract data types. Embodiments of the invention may also be practiced in distributed-computing environments where tasks are performed by remote processing devices that are linked through a communications network. In a distributed computing environment, program modules may be located in both local and remote computer storage media including memory storage devices. Additionally, the entity that may implement, or otherwise provide the ability to implement, elements of embodiments of the invention may be referred to herein as an “administrator.”

With reference to FIG. 1, an exemplary system for implementing an embodiment of the invention includes a computing device, such as computing device 100. The computing device 100 typically includes at least one processing unit 102 and memory 104.

Depending on the exact configuration and type of computing device, memory 104 may be volatile (such as random-access memory (RAM)), nonvolatile (such as read-only memory (ROM), flash memory, etc.) or some combination of the two. This most basic configuration is illustrated in FIG. 1 by dashed line 106.

Additionally, the device 100 may have additional features, aspects, and functionality. For example, the device 100 may include additional storage (removable and/or non-removable) which may take the form of, but is not limited to, magnetic or optical disks or tapes. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

The device 100 may also include a communications connection 112 that allows the device to communicate with other devices. The communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio-frequency (RF), infrared and other wireless media. The term computer-readable media as used herein includes both storage media and communication media.

The device 100 may also have an input device 114 such as keyboard, mouse, pen, voice-input device, touch-input device, etc. Further, an output device 116 such as a display, speakers, printer, etc. may also be included. Additional input devices 114 and output devices 116 may be included depending on a desired functionality of the device 100.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

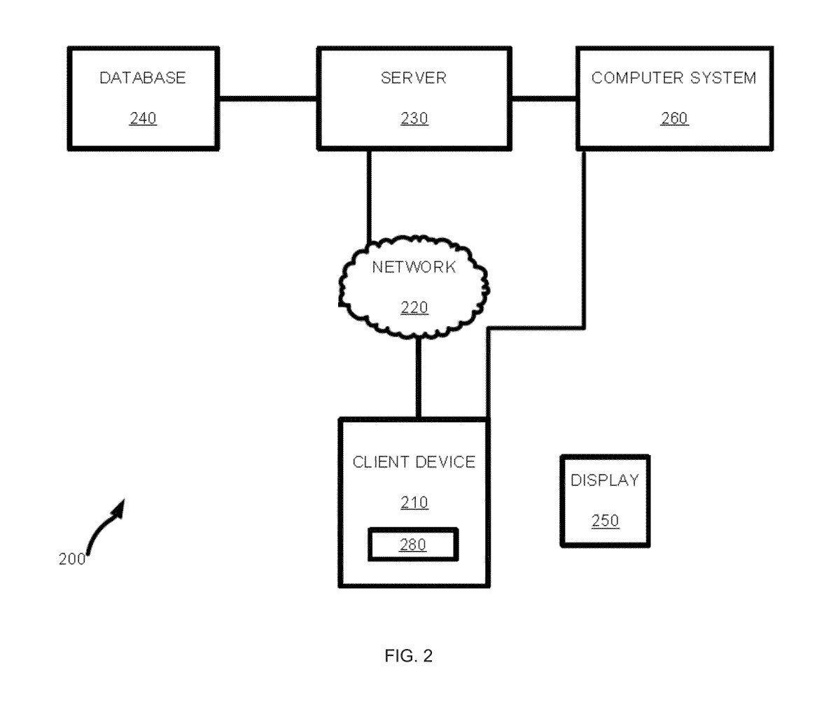

Referring now to FIG. 2, an embodiment of the present invention may take the form, and/or may be implemented using one or more elements, of an exemplary computer network system 200. The system 200 includes an electronic client device 210, such as a personal computer or workstation, tablet, smart phone or other handheld electronic device, that is linked via a communication medium, such as a network 220 (e.g., the Internet), to an electronic device or system, such as a server 230. The server 230 may further be coupled, or otherwise have access, to a database 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers.

The client device 210 and the server 230 may include all or fewer than all of the features associated with the device 100 illustrated in and discussed with reference to FIG. 1. The client device 210 includes or is otherwise coupled to a computer screen or display 250. The client device 210 may be used for various purposes such as network- and local-computing processes.

The client device 210 is linked via the network 220 to server 230 so that computer programs, such as, for example, a browser, running on the client device 210 can cooperate in two-way communication with server 230. The server 230 may be coupled to database 240 to retrieve information therefrom and to store information thereto. Database 240 may have stored therein data (not shown) that can be used by the server 230 and/or client device 210 to enable performance of various aspects of embodiments of the invention. Additionally, the server 230 may be coupled to the computer system 260 in a manner allowing the server to delegate certain processing functions to the computer system. In an embodiment, most or all of the functionality described herein may be implemented in a desktop application 280 that may include one or more executable modules. In an embodiment, the client device 210 may bypass network 220 and communicate directly with computer system 260.

Still referring to FIG. 2, and in operation according to an embodiment of the invention, a user (not shown) of the client device 210 desiring to enjoy functionality described below herein may invoke the desktop application 280. Alternatively, the user may invoke a browser running on the client device 210 to access web content, which may, but need not, be served by the server 230. Specifically, by employing an appropriate uniform resource locator (URL) in a known manner, the user may navigate to a website hosted by the server 230 and access features provided by one or more embodiments described herein.

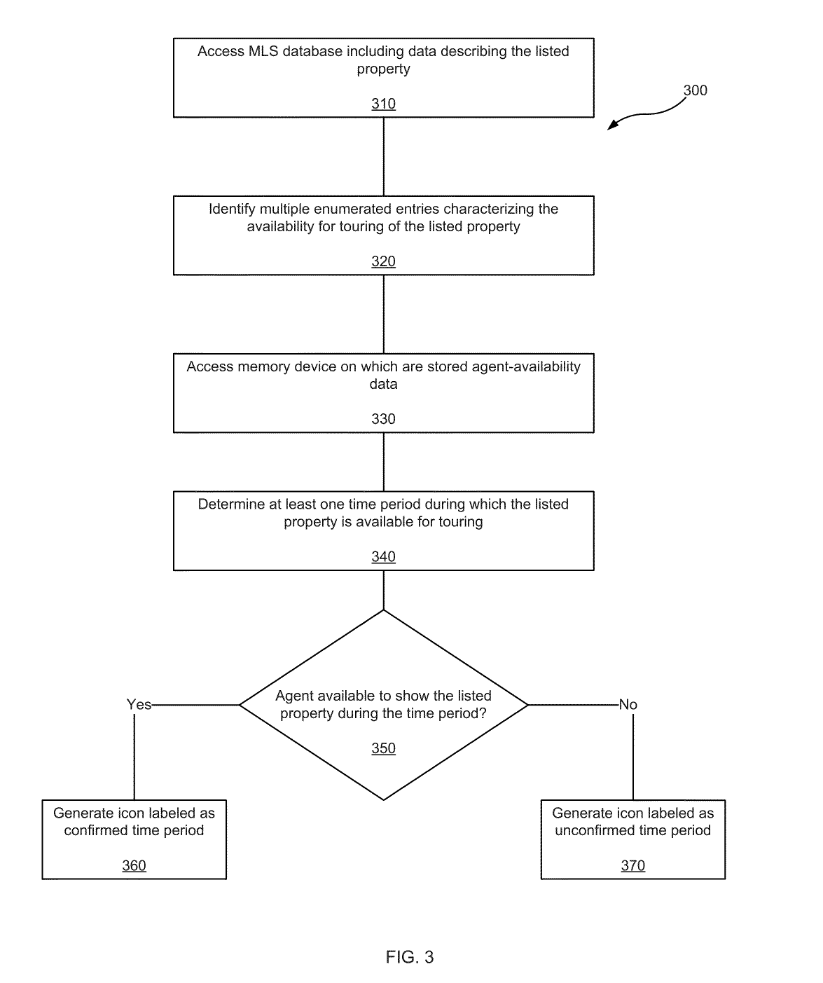

FIG. 3 illustrates a process 300, according to an embodiment of the invention, for coordinating a tour of the listed property.

The process 300 is illustrated as a set of operations shown as discrete blocks. One or more steps of the process 300 may be implemented in any suitable hardware (such as, e.g., server 230 and/or computer system 260), software, including instructions embodied within components, firmware, or combination thereof. The order in which the operations associated with the process 300 are described is not to be necessarily construed as a limitation.

At a block 310, a first electronic multiple-listing service (MLS) database (not shown) of a set of MLS databases is accessed over a network, such as network 220. This first MLS database includes data describing a listed property.

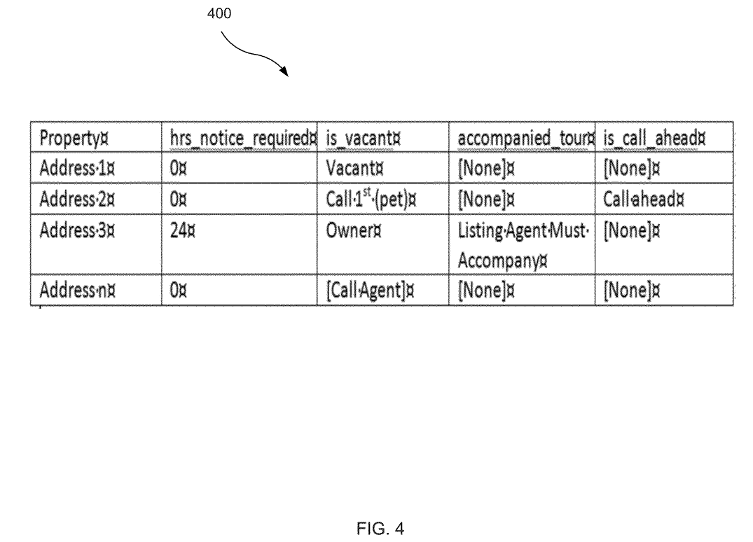

At a block 320, multiple enumerated entries characterizing the availability for touring of the listed property are identified from the data. In an embodiment, the enumerated entries are a selected predetermined subset of the MLS data describing the listed property. FIG. 4 illustrates a table 400 of such enumerated entries associated with hypothetical listed properties Address 1-Address n. In a preferred embodiment, and as shown in FIG. 4, the multiple enumerated entries on which functionality relies comprise an indicator of required hours of advanced notice to tour the property (i.e., column “hrs notice required”), an indicator of property vacancy (i.e., column “is_vacant”), and an indicator of whether a third-party agent must be present to tour the property (i.e., column “accompanied_tour”). Alternatively, the enumerated entries may further comprise an indicator of whether the prospective buyer must call ahead before access to the property may be obtained (i.e., column “is_call_ahead”).

In an embodiment, each MLS database of the set has a respective different enumerated-entry format. That is, any such database may not include one or more of the above-described enumerated entries, or may otherwise identify one or more of the above-described enumerated entries in a manner different from that illustrated in FIG. 4. Consequently, an embodiment of the process 300 may further include selecting a first entry-identifying schema from a plurality of entry-identifying schemas, or otherwise selecting from that plurality a schema appropriate to an MLS database associated with any given listed property of interest. In the exemplary embodiment, the selected first entry-identifying schema corresponds to the first MLS database referred to above.

At a block 330, a memory device, such as, for example, database 240 or computer system 260, on which are stored agent-data entries is accessed. The agent-data entries characterize the availability of one or more agents to show the listed property. For example the agent-data entries may identify agent name, location and identification of the agent's currently scheduled obligations (i.e., unavailability) and times at with the agent is not otherwise committed (i.e., availability).

At a block 340, one or more time periods during which the listed property is available for touring are determined based on the multiple enumerated entries. For example, because Address 1 illustrated in FIG. 4 requires no advance notice, is vacant and does not require the accompaniment of a third-party agent, Address 1 is considered generally available for touring. Another non-exhaustive example of the general availability of Address 1 would be if no advance notice or accompanied tour would be required, irrespective of whether Address 1 is vacant. In contrast, because the enumerated entries associated with Address 2-Address n indicate one or more restrictions on tour scheduling, Address 2-Address n may or may not be considered generally available for touring. Conclusions as to whether various combinations of the above-described enumerated entries yield a determination that a listed property is or is not generally available for touring may be altered during the course of operation of an embodiment based on empirical observations on how historically accurate the correspondence between the combination and the conclusion of general availability has been.

At a block 350, whether an agent serving the geographic location in which the listed property is located is available to show the listed property during the one or more time periods of availability is determined based on the agent-data entries described above. If more than one agent is available to show the listed property during such a time period, the touring agent may ultimately be selected based on priority factors such as, for example, the existence of a pre-existing relationship between the agent and a user choosing to tour the listed property, the minimum advance notice each agent requires between scheduling a tour and the tour's starting time, and/or the amount of time required for the agent to travel from a previous tour to the presently requested tour.

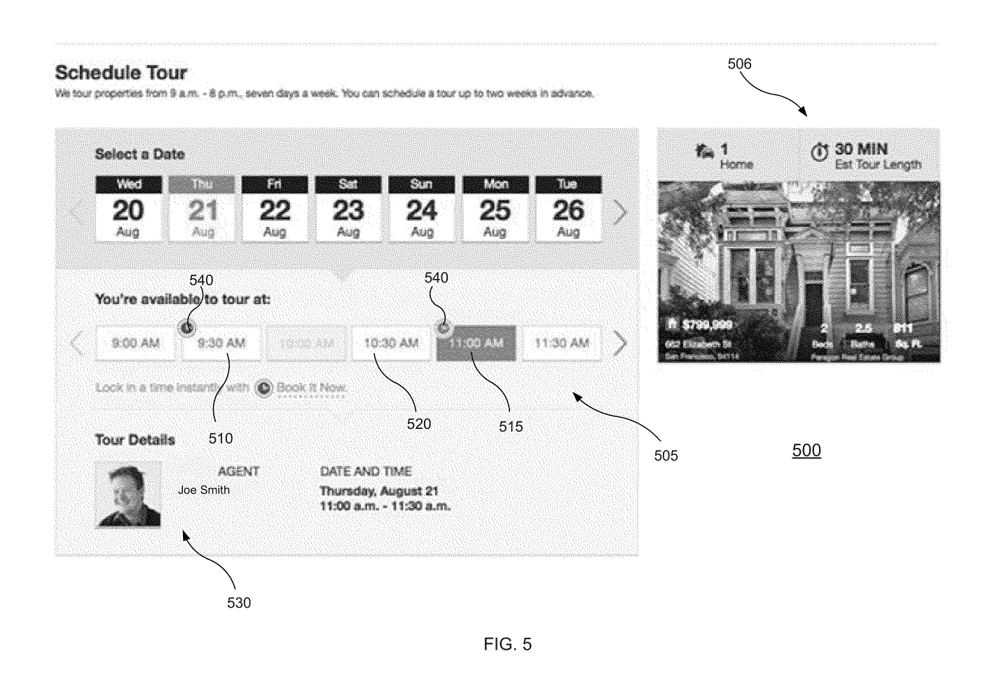

As illustrated in FIG. 5, a graphical user interface (GUI) 500 is generated to a display device, such as display device 250. The GUI 500 presents a plurality of user-selectable icons 505, some of which represent time periods during which the property is not unavailable for touring. In the example illustrated in FIG. 5, the user has selected Thursday, August 21 as a day on which the user desires to tour the property depicted in photograph 506.

At a block 360, if an agent is available to show the listed property during the one or more available time periods, one or more of the icons 510, 515 is labeled, in the illustrated example with a clock logo 540, as being associated with a confirmed time period during which the listed property is available for touring. Also in the illustrated example, the user has selected icon 515 associated with the 11 AM confirmed time period. As a consequence of this user selection, the GUI 500 presents information 530 confirming the user's appointment to tour the listed property, as well as the identity and, optionally, photograph of the agent who will conduct the tour as selected during the step associated with block 350.

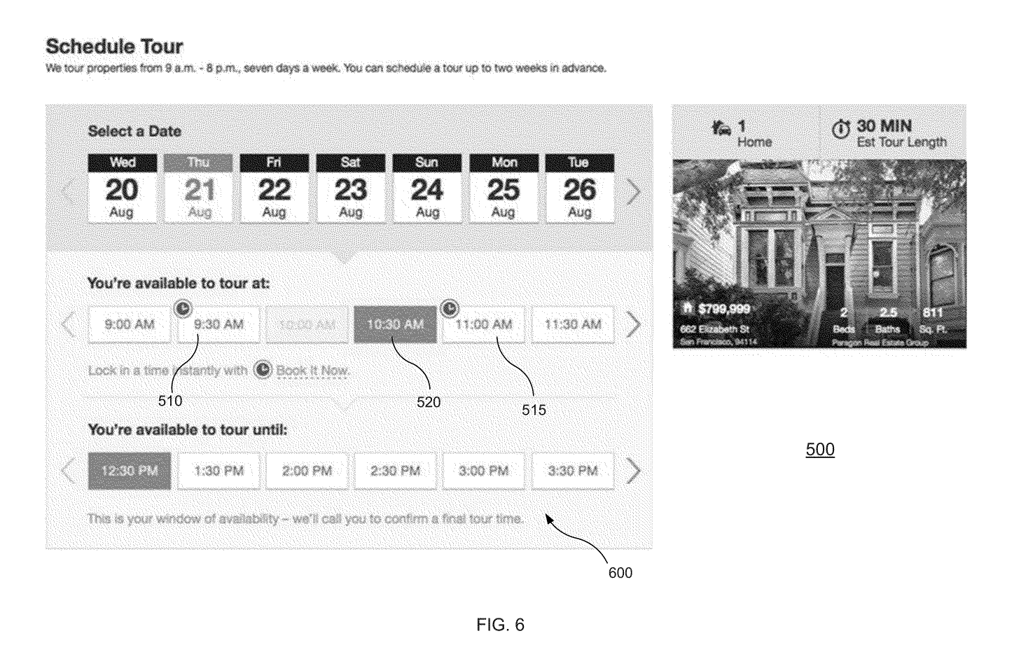

At a block 370, if no agent is confirmed as available to show the listed property during the one or more available time periods, one or more of the icons 520 is labeled as being associated with an unconfirmed time period during which the listed property is available for touring. As illustrated in FIG. 6, should the user select the icon 520 associated with the unconfirmed time period, a set of icons 600 is generated in the GUI 500 allowing the user to propose a time at which the tour will conclude, after which an agent who may be available to conduct a tour will contact the user to confirm that the user's request will be fulfilled. In an embodiment, all confirmed time periods (as well as all unconfirmed time periods) are determined prior to a user viewing or otherwise interacting with the GUI 500.

From the foregoing, it will be appreciated that specific embodiments of the personalized feed system have been described herein for purposes of illustration, but that various modifications may be made without deviating from the spirit and scope of the invention. Accordingly, the invention is not limited except as by the appended claims.

What is claimed is:

1. At least one computer-readable medium on which are stored instructions that, when executed by a processing device, enable the processing device to perform a method of coordinating a tour of a listed property, the method comprising the steps of:
accessing over a network a first electronic multiple-listing service (MLS) database of a set of MLS databases, the first MLS database including data describing the listed property;
identifying from the data multiple enumerated entries characterizing the availability for touring of the listed property;
accessing a memory device on which are stored agent-data entries characterizing the availability for showing the listed property of multiple agents;
based on the multiple enumerated entries and the agent-data entries, determining at least one confirmed time period during which the listed property is available for touring and an agent is available to show the listed property;
generating to a display device a graphical user interface (GUI), the GUI presenting a plurality of user-selectable icons representing time periods during which the property is not unavailable for touring; and
labeling at least one of the icons as being associated with a confirmed time period.

2. The medium of claim 1, wherein the enumerated entries are a selected predetermined subset of the data describing the listed property.

3. The medium of claim 1, wherein the multiple enumerated entries comprise an indicator of property vacancy.

4. The medium of claim 1, wherein the multiple enumerated entries comprise an indicator of required hours of advanced notice to tour the property.

5. The medium of claim 1, wherein the multiple enumerated entries comprise an indicator of whether a third-party agent must be present to tour the property.

6. The medium of claim 1, wherein the method further comprises labeling at least one of the icons as being associated with an unconfirmed time period.

7. The medium of claim 1, wherein the confirmed time period is determined prior to a user viewing the GUI.

8. The medium of claim 1, wherein:
each MLS database of the set has a respective different enumerated-entry format; and
the method further comprises selecting a first entry-identifying schema of a plurality of entry-identifying schemas, the first entry-identifying schema corresponding to the first MLS database.

9. The medium of claim 1, wherein the method further comprises the step of generating to the GUI, in response to a user selecting an icon associated with a confirmed time period, an identification of an agent who will show the listed property.

10. A system for automatedly coordinating a tour of a listed property, comprising:
at least one processor configured to:
access over a network a first electronic multiple-listing service (MLS) database of a set of MLS databases, the first MLS database including data describing the listed property,
identify from the data multiple enumerated entries characterizing the availability for touring of the listed property; and
at least one memory device on which are stored agent-data entries characterizing the availability for showing the listed property of multiple agents, wherein the at least one processing device is further configured to:
access a memory device on which are stored agent-data entries characterizing the availability for showing the listed property of multiple agents,
based on the multiple enumerated entries and the agent-data entries, determine at least one confirmed time period during which the listed property is available for touring and an agent is available to show the listed property,
generate to a display device a graphical user interface (GUI), the GUI presenting a plurality of user-selectable icons representing time periods during which the property is not unavailable for touring, and
label at least one of the icons as being associated with a confirmed time period.

11. The system of claim 10, wherein the enumerated entries are a selected predetermined subset of the data describing the listed property.

12. The system of claim 10, wherein the multiple enumerated entries comprise an indicator of property vacancy.

13. The system of claim 10, wherein the multiple enumerated entries comprise an indicator of required hours of advanced notice to tour the property.

14. The system of claim 10, wherein the multiple enumerated entries comprise an indicator of whether a third-party agent must be present to tour the property.

15. The system of claim 10, wherein the at least one processing device is further configured to label at least one of the icons as being associated with an unconfirmed time period.

16. The system of claim 10, wherein the confirmed time period is determined prior to a user viewing the GUI.

17. The system of claim 10, wherein:
each MLS database of the set has a respective different enumerated-entry format; and
the at least one processing device is further configured to select a first entry-identifying schema of a plurality of entry-identifying schemas, the first entry-identifying schema corresponding to the first MLS database.

18. The system of claim 10, wherein the at least one processing device is further configured to generate to the GUI, in response to a user selecting an icon associated with a confirmed time period, an identification of an agent who will show the listed property.
